(19) United States
(12) Patent Application Publication
(10) Pub. No.: US 2023/0004021 A1
(43) Pub. Date: Jan. 5, 2023

(54) EYEGLASSES

(71) Applicant: Kai Fang, Wenzhou City (CH)

(72) Inventor: Kai Fang, Wenzhou City (CH)

(73) Assignee: Wenzhou Eyekepper Technology Co., Ltd, Wenzhou City (CH)

(21) Appl. No.: 17/364,918

(22) Filed: Jul. 1, 2021

(51) Int. Cl. G02C 1/08; G02C 5/04

(52) U.S. Cl. CPC G02C 1/08; G02C 5/04; G02C 2200/08

(57) ABSTRACT

A snap fit eyeglasses frame includes a left eyeglass frame portion and a right eyeglass frame portion which can be separated. There is a male connector portion of the left side eyeglasses frame portion, and there is a female connector portion of the right side eyeglasses frame portion 20, whereby the male and female connector portions are assembled together when securing the left and right frame portions together. There is an aperture in the female connector portion to receive a locking member, which also will serve as the release member. The male connector portion has the release member which is deformed or bent out of the way during assembly, and which after assembly is urged toward a position where it extends through the aperture in the female connector portion The release member provided on the male connector portion.

### CROSS REFERENCE TO RELATED APPLICATIONS

None.

### STATEMENT REGARDING FEDERALLY SPONSORED RESEARCH OR DEVELOPMENT

Not applicable.

### FIELD OF THE INVENTION

The present invention relates to construction of eyeglasses, and in particular to eyeglasses that can be assembled and disassembled manually such that one part can be replaced by another part by a user.

### BACKGROUND OF THE INVENTION

It is a problem in the art to provide eyeglasses that can be customized by a user, and/or repaired by a user.

Known eyeglasses are constructed with a frame that is unitary and typically molded as one piece. However, this does not permit customization or repair of the frame.

This can be significant to a user when the user's features are not symmetrical and where a given frame will correctly hold a lens in a correct position for only one eye or the other eye, when the eyes are at different elevations on an asymmetrical face for example.

Additionally, manual disassembly and assembly can be desirable where compactness is important to a user, such as for carrying eyeglasses during travel in such a manner that they are less likely to break.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides an eyeglasses construction such that a left side frame portion and a right side frame portion are manually disassembleable and manually assembleable. That is, they can be manually assembled and disassembled.

In particular, the invention is directed to eyeglasses that can be assembled and disassembled manually such that one part can be replaced by another part by a user, and to a snap fit construction wherein a male part and a female part can be secured together so that they are locked together, and with an unlocking mechanism for unlocking the male and female parts.

The invention is directed to a snap fit eyeglasses frame which is assembleable and disassembeable, comprising:
a left eyeglass frame portion;
a right eyeglass frame portion;
said left eyeglass frame portion having a male connector portion;
said right eyeglass frame portion having a female connector portion;
said female connector portion having a cavity adapted to receive said male connector portion, and having an aperture therein in communication with said cavity;
said male connector portion having a release portion adapted to be received in said aperture of said female connector portion for locking said female connector portion with said male connector portion, and said release portion being manually engageable through said aperture for manual release by depressing said release portion so that said male connector portion can be removed from said cavity of said female connector portion;
whereby said left eyeglass portion and said right eyeglass portion are manually assembleable and manually disassembleable.

The female connector body has an upper abutment portion for contacting said left eyeglass frame portion, and a lower abutment portion for contacting said left eyeglass frame portion. The cavity is substantially in the form of a rectangular prismatic shape. The male connector portion has a substantially rectangular prismatic shape adapted to be snugly received in said cavity. And, the female connector portion includes a female connector body and a pair of projecting members.

The invention is further directed to a male connector portion which includes a male connector body having a generally U-shaped portion adapted to be received within said cavity, and said release portion being mounted within said U-shaped portion so as to be resiliently deformable.

The invention is further directed to a snap fit eyeglasses frame comprising: a pair of nosepieces respectively connected to said left eyeglass frame portion and said right eyeglass frame portion; a pair of temples respectively connected to said left eyeglass frame portion and said right eyeglass frame portion; and a pair of hinges respectively connected to said left eyeglass frame portion and said right eyeglass frame portion.

Other objects and advantages of the present invention will be more readily apparent from the following detailed description when read in conjunction with the accompanying drawings.

### BRIEF DESCRIPTION OF THE DRAWINGS

FIG. 1 is a front elevational view of an eyeglasses frame according to the present invention.

FIG. 2 is front elevational view of the eyeglasses frame of FIG. 1 with a left eyeglass frame portion and a right eyeglass frame portion separated from each other.

FIG. 3 is a rear elevational view of the eyeglasses frame of FIG. 1.

FIG. 4 is a rear elevational view of the eyeglasses frame of FIG. 3 with a left eyeglass frame portion and a right eyeglass frame portion separated from each other.

FIG. 5 is a front perspective view of the eyeglasses frame of FIG. 1.

FIG. 6 is a front perspective view of the eyeglasses frame of FIG. 5 with a left eyeglass frame portion and a right eyeglass frame portion separated from each other.

FIG. 7 is a front perspective close sectional view of the left eyeglass frame portion and the right eyeglass frame portion partially assembled, showing a male connector portion of the left side eyeglasses frame portion entering a female cavity in the right side eyeglasses frame portion.

FIG. 8 is a front perspective close sectional view of the left eyeglass frame portion and the right eyeglass frame portion in close proximity, showing a male connector portion of the left side eyeglasses frame portion entering a female cavity in the right side eyeglasses frame portion.

FIG. 9 is a rear perspective view from below of the eyeglasses frame of FIG. 5, with a left eyeglass frame portion and a right eyeglass frame portion separated from each other.

FIG. 10 is a rear perspective close view of the left eyeglass frame portion and the right eyeglass frame portion of FIG. 8 fully separated, showing the male connector portion of the left side eyeglasses frame portion and a female connector portion of right side eyeglasses frame portion.

FIG. 11 is a side elevational view of the left side frame portion, showing the male connector portion 40 and the left frame portion nosepiece.

FIG. 12 is a side elevational view of the right side frame portion, showing the female connector portion 30 and the right frame portion nosepiece.

FIG. 13 is a left rear elevational view of the left side frame portion, greatly enlarged, showing the left frame portion nosepiece and the male connector portion 40.

FIG. 14 is a rear elevational view from the left of the right side frame portion, greatly enlarged, showing the right frame portion nosepiece and the female connector portion 30.

FIG. 15 is a top plan view of the eyeglasses frame of FIG. 1.

FIG. 16 is a top plan view of the eyeglasses frame of FIG. 2 with the left eyeglass frame portion and the right eyeglass frame portion separated from each other.

FIG. 17 is a bottom view of the eyeglasses frame of FIG. 1.

FIG. 18 is a bottom view of the eyeglasses frame of FIG. 2 with the left eyeglass frame portion and the right eyeglass frame portion separated from each other.

FIG. 19 is a left elevational view of the eyeglasses frame of FIG. 1.

### DETAILED DESCRIPTION OF THE INVENTION

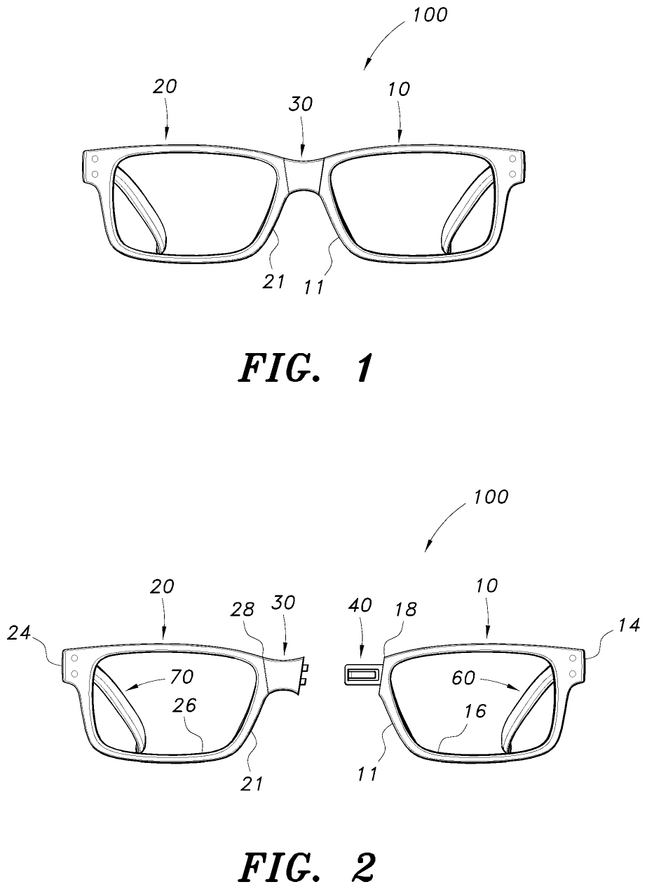

FIG. 1 is a front elevational view of an eyeglasses frame 100 according to the present invention.

This is a snap fit eyeglasses frame 100 (hereafter “frame 100”). The frame 100 has a left eyeglass frame portion 10 and a right eyeglass frame portion 20. The left eyeglass frame portion 10 has a lower frame section 11 for supporting a lens, and the right eyeglass frame portion 20 has a lower frame section 21 for supporting a lens. The right eyeglass frame portion 20 includes a female connector portion 30, which is discussed in further detail below in connection with the other figures of drawing.

The lenses are omitted for the sake of clarity, and such lenses are conventional in the eyeglasses art.

Specifically, the frame 100 according to the present invention provides an eyeglasses construction such that a left side 10 and a right side 20 are manually disassembleable and manually assembleable.

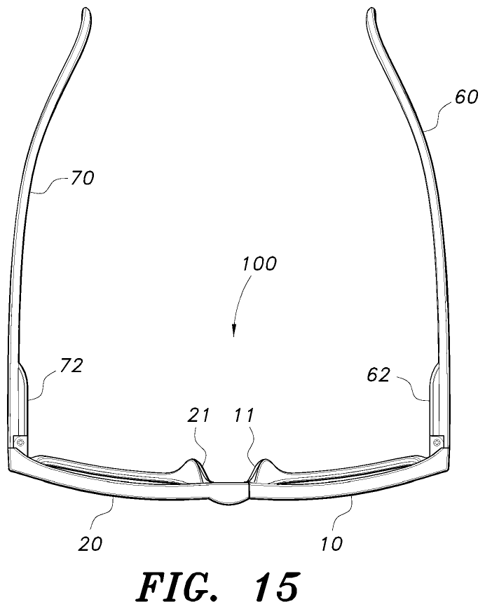

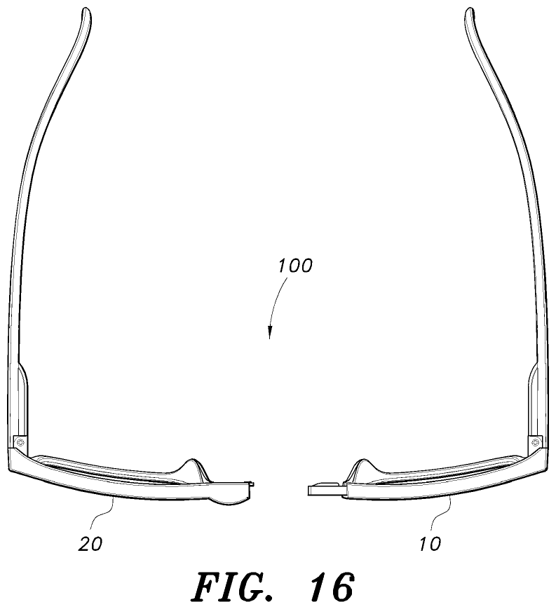

FIG. 2 is front elevational view of the eyeglasses frame 100 of FIG. 1 with the left eyeglass frame portion 10 and the right eyeglass frame portion 20 separated from each other. The left eyeglass frame portion 10 has a leftmost end 14 which supports a hinge (shown in FIG. 15), a temple or earpiece 60, a frame inner edge 16, a frame top corner portion 18, and the male connector portion 40.

The right eyeglass frame portion 20 has a rightmost end 24 which supports a hinge (shown in FIG. 15), a temple or earpiece 70, a frame inner edge 26, a frame top corner portion 28, and the female connector portion 30.

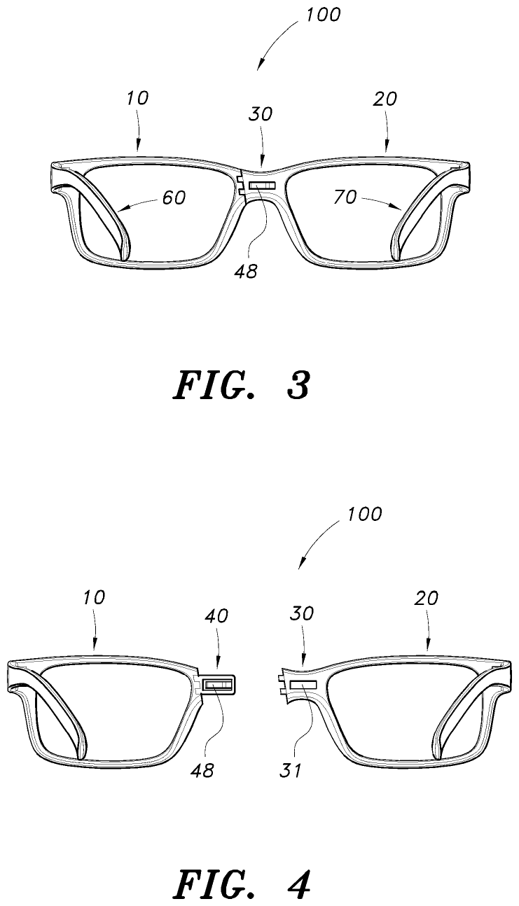

In particular, the invention is directed to the eyeglasses frame 100 which can be assembled and disassembled manually such that one part (e.g. the left eyeglass frame portion 10 or the right eyeglass frame portion 20) can be replaced by another, and the invention is further directed to a snap fit construction wherein the left eyeglass frame portion 10 and the right eyeglass frame portion 20 can be secured together so that they are locked together, and with an unlocking mechanism for unlocking the left eyeglass frame portion 10 and the right eyeglass frame portion 20. The unlocking mechanism involves the release member 48 (shown in FIG. 3), and the manner of operation is explained further below.

FIG. 3 is a rear elevational view of the eyeglasses frame 100 of FIG. 1. The parts shown are as discussed above. A release member 48 is shown which is part of the male connector portion 40 and is discussed with reference to the following figures below. The release member 48 is visible through an opening or aperture 31 in the female connector portion 30 (shown in FIG. 4), which allows manual depression of the release member 48 to unlock the connection between the female connector portion 30 and the male connector portion 40 as shown and discussed with regard to the following figures.

FIG. 4 is a rear elevational view of the eyeglasses frame 100 of FIG. 3 with the left eyeglass frame portion 10 and the right eyeglass frame portion 20 separated from each other. This view shows the 48 of the male connector portion 40 and the opening 31 in the female connector portion 30.

FIG. 5 is a front perspective view of the eyeglasses frame 100 of FIG. 1.

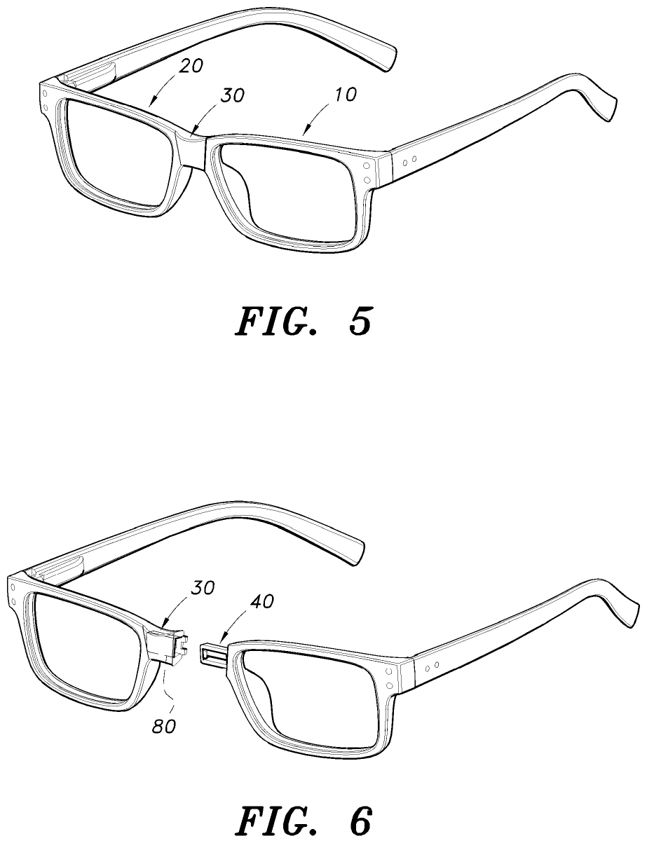

FIG. 6 is a front perspective view of the eyeglasses frame 100 of FIG. 5 with the left eyeglass frame portion 10 and the right eyeglass frame portion 20 separated from each other. In this view, the female connector portion 30 and male connector portion 40 are shown.

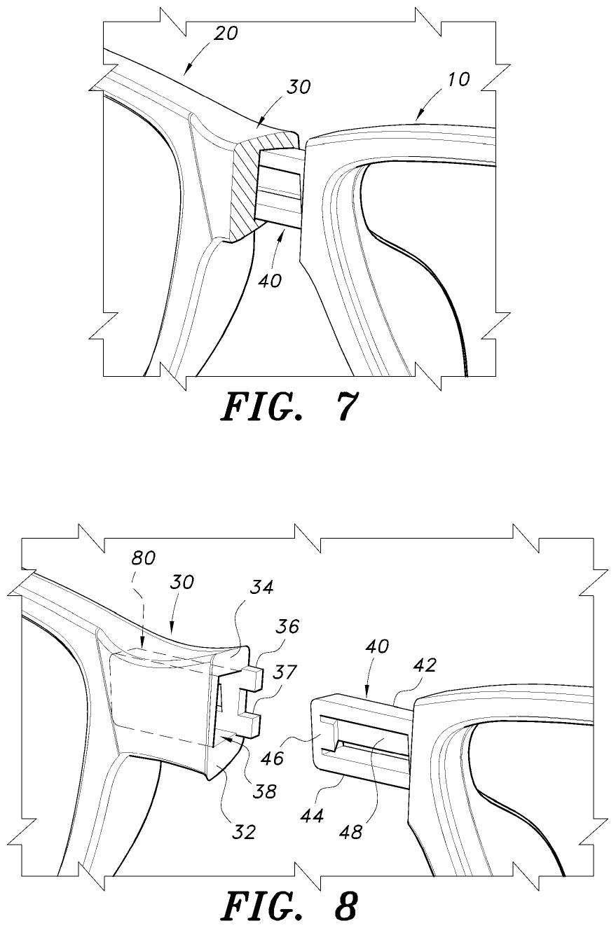

FIG. 7 is a front perspective close sectional view of the left eyeglass frame portion 10 and the right eyeglass frame portion 20 partially assembled, showing the male connector portion 40 of the left side eyeglasses frame portion 10 entering a female cavity 38 (shown in FIG. 8) in the right side eyeglasses frame portion 20.

FIG. 8 is a front perspective close sectional view of the left eyeglass frame portion 10 and the right eyeglass frame portion 20 in close proximity, partially assembled, showing the male connector portion 40 of the left side eyeglasses frame portion 10 entering the female cavity 38 in the right side eyeglasses frame portion 20. The male connector portion 40 has a top portion 42, a lower portion 44, and an end portion 46 connecting the top portion 42 and the bottom portion 44. The release member 48 is connected with the end portion 46 in a cantilever manner such that the release member 48 can be depressed to unlock the connection between the left eyeglass frame portion 10 and the right eyeglass frame portion 20.

As shown in FIG. 8, the female connector portion 30 has an abutment portion 34 which abuts the portion 18 of the left eyeglass frame portion 10. The female connector portion 30 has an abutment surface 32 which likewise abuts the left eyeglass frame portion 10, forming a tight fit when assembled. The female connector portion 30 includes the female cavity 38, and has a body portion 80 shown in dashed outline in this view, and a pair of projecting members 36 and 37 extending from the body portion 80.

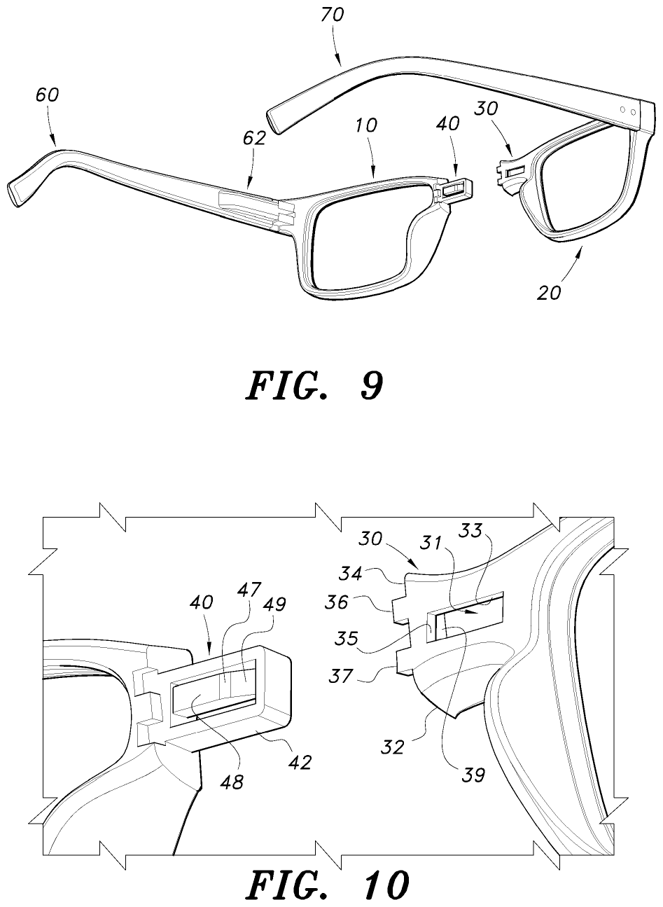

FIG. 9 is a rear perspective view from below of the eyeglasses frame 100 of FIG. 5, with the left eyeglass frame portion 10 and the right eyeglass frame portion 20 separated from each other. A hinge 62 is shown in this view, and can be any type of a conventional hinge used in eyeglasses construction.

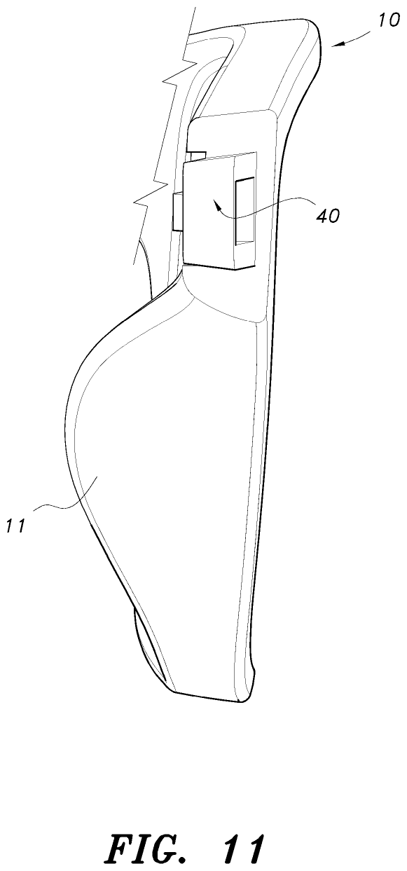

FIG. 10 is a rear perspective close view of the left eyeglass frame portion 10 and the right eyeglass frame portion 20 of FIG. 8 fully separated, showing the male connector portion 40 of the left side eyeglasses frame portion 10 and the female connector portion 30 of the right side eyeglasses frame portion 20.

As shown in FIG. 10, the female connector portion 30 includes the aperture 31 bounded by a wall 33 which has an end wall portion 35 and deflecting portion 39 which deflects the release member 48 during entry of the male connector portion 40 into the female connector portion 30. The release member returns to an undeflected state when it can expand into the aperture 31.

As shown in FIG. 10, the male connector portion 40 includes the release member 48, which has a sloped portion 49 to enter the female cavity portion 38 and an intermediate portion 47. In operation, entry of the sloped portion of the male connector portion 40 into the cavity portion 38 deflects the release member 48 which after entry into the cavity portion 38 returns to its original undeflected state when the release member 48 is fully inserted into the female connector portion 30 such that the release member 48 can enter into the aperture 31. The release member 48 is resiliently deformable, so that when deflected it can return to its original state in a spring-like manner.

FIG. 11 is a side elevational view of the left side frame portion 10, showing the male connector portion 40 and a left frame portion nosepiece 11.

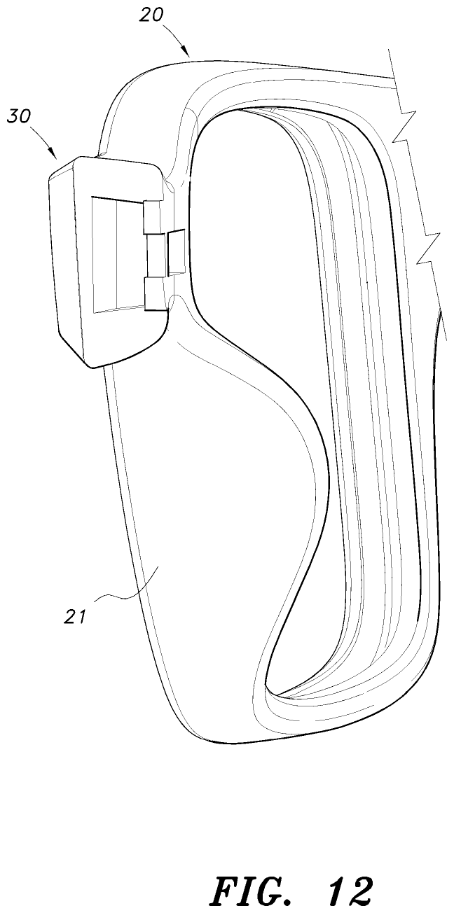

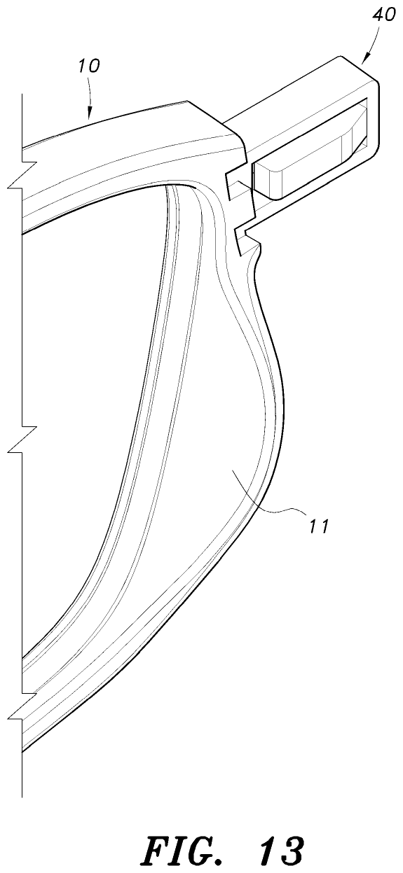

FIG. 12 is a side elevational view of the right side frame portion 20, showing the female connector portion 30 and the right frame portion nosepiece 21.

FIG. 13 is a left rear elevational view of the left side frame portion 10, greatly enlarged, showing the left frame portion nosepiece 11 and the male connector portion 40.

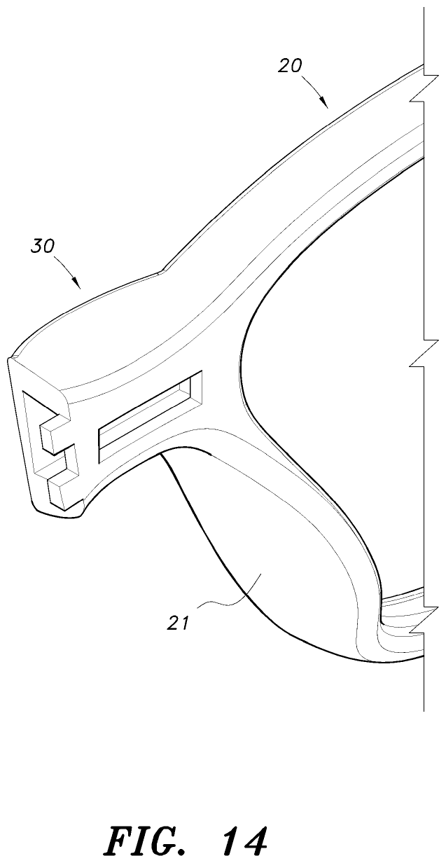

FIG. 14 is a rear elevational view from the left of the right side frame portion 20, greatly enlarged, showing the right frame portion nosepiece 21 and the female connector portion 30.

FIG. 15 is a top plan view of the eyeglasses frame 100 of FIG. 1. Here, the temple portions 60 and 70 are shown, along with hinge elements 62 and 72. The nosepieces 11 and 21 are also shown.

FIG. 16 is a top plan view of the eyeglasses frame of FIG. 2 with the left eyeglass frame portion 10 and the right eyeglass frame portion 20 separated from each other.

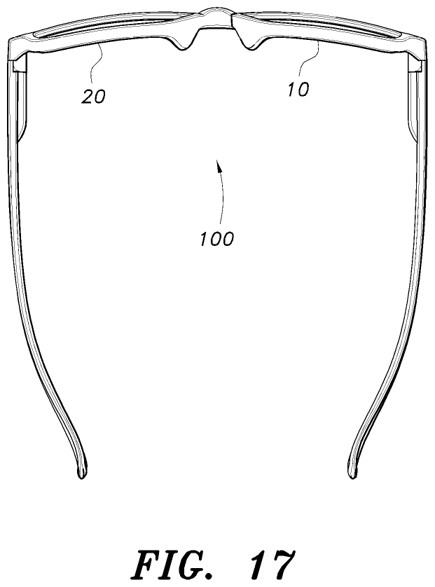

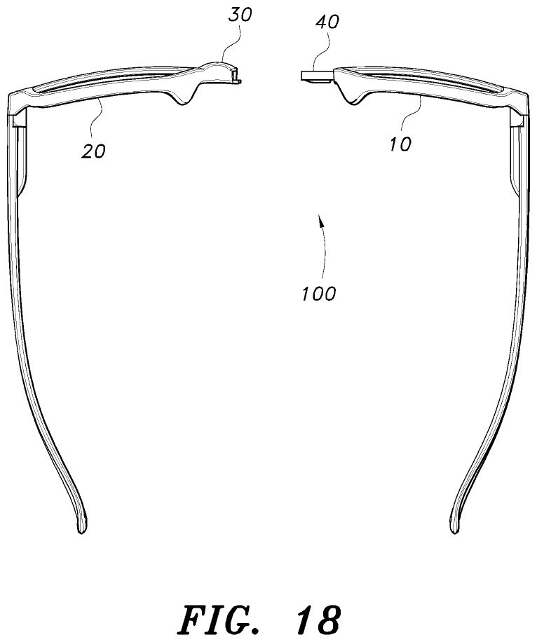

FIG. 17 is a bottom view of the eyeglasses frame 100 of FIG. 1, showing the portions 10 and 20 connected.

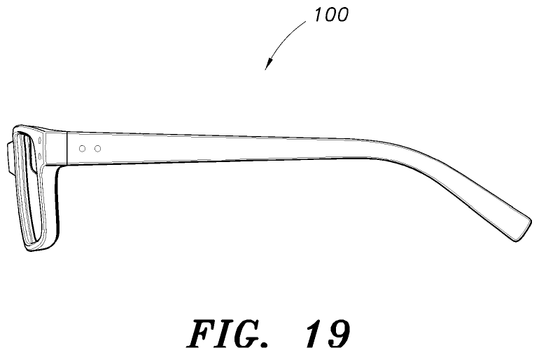

FIG. 18 is a bottom view of the eyeglasses frame of FIG. 2 with the left eyeglass frame portion 10 and the right eyeglass frame portion 20 separated from each other.

FIG. 19 is a left elevational view of the eyeglasses frame 100 of FIG. 1. A right side view would be similar.

The frame 100 of the present invention can be constructed of any materials suitable for eyeglasses frames, and which would be known to any one having skill in the eyeglass frame art.

Specifically, the device according to the present invention provides an eyeglasses construction such that the left side 10 and the right side 20 are manually disassembleable and manually assembleable.

In particular, the invention is directed to eyeglasses that can be assembled and disassembled manually such that one part can be replaced by another part by a user, and to a snap fit construction wherein a male part and a female part can be secured together so that they are locked together, and with an unlocking mechanism for unlocking the male and female parts.

The release member 48 can, in an alternative embodiment, be composed of a compressible material, so that it simply deforms under pressure during assembly and recovers its original form when fully assembled such that it expands through the aperture or opening. In this manner, it can lock and unlock the connection of the elements 30 and 40 as described above.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A snap fit eyeglasses frame which is assembleable and disassembeable, comprising:
a left eyeglass frame portion;
a right eyeglass frame portion;
said left eyeglass frame portion having a male connector portion;
said right eyeglass frame portion having a female connector portion;
said female connector portion having a cavity adapted to receive said male connector portion, and having an aperture therein in communication with said cavity;
said male connector portion having a release portion adapted to be received in said aperture of said female connector portion for locking said female connector portion with said male connector portion, and said release portion being manually engageable through said aperture for manual release by depressing said release portion so that said male connector portion can be removed from said cavity of said female connector portion;
whereby said left eyeglass portion and said right eyeglass portion are manually assembleable and manually disassembleable.

2. A snap fit eyeglasses frame as claimed in claim 1, wherein said female connector portion includes a female connector body having said cavity.

3. A snap fit eyeglasses frame as claimed in claim 1, wherein said female connector portion includes a female connector body having an upper abutment portion for contacting said left eyeglass frame portion, and a lower abutment portion for contacting said left eyeglass frame portion.

4. A snap fit eyeglasses frame as claimed in claim 1, wherein said female connector portion includes a female connector body having said cavity, wherein said cavity is substantially in the form of a rectangular prismatic shape; and wherein said male connector portion has a substantially rectangular prismatic shape adapted to be snugly received in said cavity.

5. A snap fit eyeglasses frame as claimed in claim 1, wherein said female connector portion includes a female connector body and a pair of projecting members.

6. A snap fit eyeglasses frame as claimed in claim 1, wherein said male connector portion includes a male connector body having a generally U-shaped portion adapted to be received within said cavity, and said release portion being mounted within said U-shaped portion so as to be resiliently deformable.

7. A snap fit eyeglasses frame as claimed in claim 1, further comprising:
a pair of nosepieces respectively connected to said left eyeglass frame portion and said right eyeglass frame portion;
a pair of temples respectively connected to said left eyeglass frame portion and said right eyeglass frame portion; and
a pair of hinges respectively connected to said left eyeglass frame portion and said right eyeglass frame portion.
